(19) United States
(12) Patent Application Publication
(10) Pub. No.: US 2014/0108561 A1
(43) Pub. Date: Apr. 17, 2014

(54) METHODS FOR DISTRIBUTING ENTITY NEWS ITEMS VIA A COMPUTER SYSTEM

(71) Applicant: Gordon Seay, San Diego, CA (US)

(72) Inventor: Gordon Seay, San Diego, CA (US)

(21) Appl. No.: 13/651,121

(22) Filed: Oct. 12, 2012

(51) Int. Cl. G06F 15/16

(52) U.S. Cl. 709/206

(57) ABSTRACT

A method for distributing entity news items to one or more select users via a computer system including a central processing unit and a shared data storage cooperating with the central processing unit, the method comprising the steps of: receiving a plurality of entity news items for a plurality of entities into the shared data storage; associating, with the central processing unit executing computer executable instructions, an entity identifier with each entity news item to correlate each entity news item with a given entity; associating, with the central processing unit executing computer executable instructions, one or more selected entities with a controlling user based on the entity identifier to define a controlling user set of entities; associating, with the central processing unit executing computer executable instructions, a subscribing user with the controlling user so that the subscribing user receives entity news items associated with the one or more selected entities included in the controlling user set of entities; and distributing to the subscribing user, with the central processing unit executing computer executable instructions, entity news items associated with the one or more selected entities included in the controlling user set of entities to the subscribing user.

### BACKGROUND

The present disclosure relates generally to methods for distributing news items. In particular, methods for distributing entity news items via a computer system are described.

Known methods for distributing entity news items via a computer system are not entirely satisfactory for the range of applications in which they are employed. For example, existing methods often require extensive management by users and administrators. Some existing methods require that an individual create and manage a personal list of entities in order to receive entity news items associated with the listed entities. Multiple people may desire to receive entity news items for the same entities; each person having to create the same list of entities is duplicative and inefficient.

In some instances, people may share distribution lists to somewhat reduce the inefficiency of each person creating their own list. However, this approach is prone to inconsistency and omission of key news items because the individuals sharing lists must share their lists anew each time one of them changes the entities included in the distribution list. It is plain to see that needing to exchange new distribution lists on an individual to individual basis quickly becomes unworkable as the pool of individuals increases and/or when the number of entities in the list increases and/or when the frequency of updating entity information increases.

Other conventional solutions force list administrators to regularly update distribution lists each time a new entity is added to a distribution list, or when an individual receiving updates desires to change what news items he receives. Likewise, adding or removing new people to existing distribution lists becomes tedious with existing solutions. A lack of granular control over which individuals receive entity news items for a given group of entities is one limitation of conventional methods.

Thus, there exists a need for a method of distributing entity news items conveniently and efficiently without extensive management by administrators or other users controlling the list or by users receiving entity news items. Further, there is a significant need for distribution methods that can flexibly handle changes to the entities compiled in a distribution list and to the users receiving entity news items.

In addition, conventional methods do not sufficiently safeguard the confidential nature of entity lists. Assembling lists of entities often involves expending considerable time, money, and effort, and the entities themselves may consist of valued personal contacts or business trade partners. In many instances, lists of entities represent valuable trade secrets to the party who has assembled the list. Revealing the identities of the entities included in the list can forfeit the substantial value associated with the list and can compromise future business opportunities.

Conventional methods of distributing entity news items often require that subscribing users be given some sort of access to the entity list, thus, compromising the identities of those entities on the list. Thus, there exists a need for a method of distributing entity news items that limits access to the identity of the entities making up a distribution list. Further, there exists a need for a method enabling entity news items to be conveniently distributed without revealing the identities of the entities making up an entity list.

As the reader can appreciate, there exists a pressing need for methods that improve upon and advance the design of known methods for distributing entity news items via computer systems. Examples of new and useful methods relevant to the needs existing in the field are discussed below.

### SUMMARY

The present disclosure is directed to methods for distributing entity news items to one or more select users via a computer system including a central processing unit and a shared data storage cooperating with the central processing unit. One example method includes the steps of receiving a plurality of entity news items for a plurality of entities into the shared data storage; associating, with the central processing unit executing computer executable instructions, an entity identifier with each entity news item to correlate each entity news item with a given entity; associating, with the central processing unit executing computer executable instructions, one or more selected entities with a controlling user based on the entity identifier to define a controlling user set of entities; associating, with the central processing unit executing computer executable instructions, a subscribing user with the controlling user so that the subscribing user receives entity news items associated with the one or more selected entities included in the controlling user set of entities; and distributing to the subscribing user, with the central processing unit executing computer executable instructions, entity news items associated with the one or more selected entities included in the controlling user set of entities to the subscribing user.

### BRIEF DESCRIPTION OF THE DRAWINGS

FIG. 1 is a block-diagram view of a programmable computing device for carrying out the methods for distributing entity news items via a computer system.

FIG. 2 is a block-diagram view illustrating a method for distributing entity news items via the computer system shown in FIG. 1.

FIG. 3 is a flow diagram of a first method for distributing entity news items via a computer system.

FIG. 4 is a flow diagram of the first method for distributing entity news items via a computer system shown in FIG. 1 with additional optional steps.

FIG. 5 is a flow diagram of a second method for distributing entity news items via a computer system.

FIG. 6 is a flow diagram of the second method for distributing entity news items via a computer system with additional optional steps.

FIG. 7 is a flow diagram of a third method for distributing entity news items via a computer system.

FIG. 8 is a flow diagram of the third method for distributing entity news items via a computer system with additional optional steps.

### DETAILED DESCRIPTION

The disclosed methods will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various methods are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

The following detailed description includes definitions of selected terms employed herein. The definitions include various examples and/or forms of components that fall within the scope of a term and that may be used to implement the disclosed methods. The examples are not intended to be limiting. Both singular and plural forms of terms may be within the definitions.

As used in this application, the term “computing unit” refers to a computer-related entity, hardware, firmware, software, a combination thereof, or software in execution. For example, a computing unit can be, but is not limited to being, a process running on a processor unit, a processor, an object, an executable, a thread of execution, a program, and a computer. By way of illustration, both an application running on a server and the server can be computing units. One or more computing units can reside within a process and/or thread of execution and a computing unit can be localized on one computer and/or distributed between two or more computers.

“System memory,” as used herein, refers to a medium that participates directly or indirectly to provide signals, instructions and/or data. A system memory may take forms, including, but not limited to, non-volatile media, and volatile media. Non-volatile media may include, for example, optical or magnetic disks and so on. Volatile media may include, for example, optical or magnetic disks, dynamic memory and the like. Common forms of a system memory include computer-readable medium such as, but not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, and other media from which a computer, a processor or other electronic device can read.

“Shared data storage,” as used herein, refers to a physical and/or logical entity that can store data. Data storage may be, for example, a database, a table, a file, a list, a queue, a heap, a memory, a register, a file directory, a storage location, and so on. Data storage may reside in one logical and/or physical entity and/or may be distributed between two or more logical and/or physical entities.

“Logic,” as used herein, includes but is not limited to, hardware, firmware, software and/or combinations of each to perform a function(s) or an action(s), and/or to cause and execute a function or action from another logic, method, and/or system. For example, based on a desired application or needs, logic may include a software controlled microprocessor, discrete logic like an application specific integrated circuit (ASIC), a programmed logic device like a field programmable gate array (FPGA), a memory device containing instructions, combinations of logic devices, or the like. Logic may include one or more gates, combinations of gates, or other circuit components. Logic may also be fully embodied as software, or may be a computing unit as defined herein. Where multiple logical logics are described, it may be possible to incorporate the multiple logical logics into one physical logic. Similarly, where a single logical logic is described, it may be possible to distribute that single logical logic between multiple physical logics.

“Software,” as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, PHP, SQL, APIs, SDKs, assembly, firmware, microcode, and/or other languages and tools. Software, whether an entire system or a component of a system, may be embodied as an article of manufacture and maintained or provided as part of a computer-readable memory as indicated previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User,” as used herein, includes but is not limited to, one or more persons, software, computers or other devices, or combinations of these.

The term “entity identifier” as used herein, is defined as a computer-generated variable that is assigned to each entity news item in order to correlate each of the entity news items with a given entity.

“Entity,” as used herein, includes, but is not limited to, an organization, business, individual, or any other type of networking group or association.

The term “set of entities” as used herein, is defined as a plurality of entities that are associated with a controlling user.

The term “entity news item” as used herein, is defined as information related to the organization, business entity, an individual, or any other type of networking group or association.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like defining, receiving, comparing, displaying, or the like, refer to actions and processes of a computer system, logic, processor, or similar electronic device that manipulates and transforms data represented as physical (electronic) quantities.

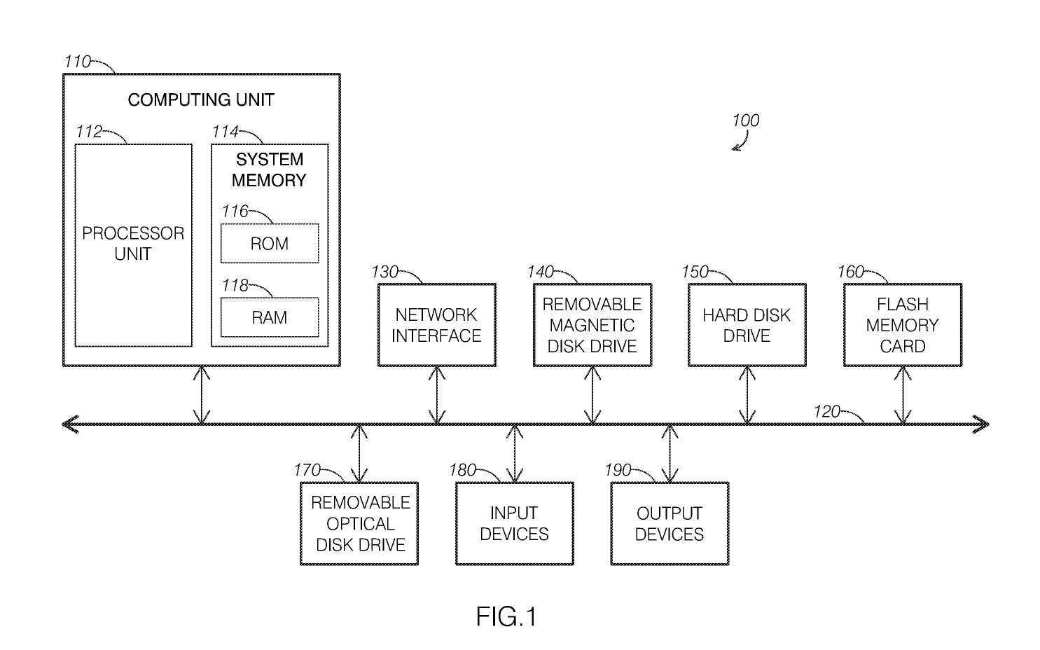

Referring to the drawings, wherein like reference numerals represent like parts throughout the various drawing figures, FIG. 1 shows a block-diagram view of a programmable computing device 100.

Accordingly, FIG. 1 shows one illustrative example of a computer 100 that can be used to implement various embodiments of the invention. The computer 100 may be incorporated within a variety of consumer electronic devices, such as personal media players, cellular phones, smart phones, personal data assistants, global positioning system devices, electronic tablets, and the like.

As seen in this figure, computer 100 has a computing unit 110. Computing unit 110 typically includes a processor or processing unit 112 and a system memory 114. Processing unit 112 may be any type of processing device for executing software instructions, but will conventionally be a microprocessor device. System memory 114 may include both a read-only memory (ROM) 116 and a random access memory (RAM) 118. As will be appreciated by those of ordinary skill in the art, both read-only memory (ROM) 116 and random access memory (RAM) 118 may store software instructions to be executed by processing unit 112.

Processing unit 112 and system memory 114 are connected, either directly or indirectly, through a bus 120 or alternate communication structure to one or more peripheral devices. For example, processing unit 112 or system memory 114 may be directly or indirectly connected to additional memory storage, such as a removable magnetic disk drive 140, a hard disk drive 150, a flash memory card 160, and a removable optical disk drive 170. Processing unit 112 and system memory 114 also may be directly or indirectly connected to one or more input devices 180 and one or more output devices 190. Input devices 180 may include, for example, a keyboard, touch screen, a remote control pad, a pointing device (such as a mouse, touchpad, stylus, trackball, or joystick), a scanner, a camera or a microphone. Output devices 190 may include, for example, a monitor display, an integrated display, television, printer, stereo, or speakers.

Still further, computing unit 110 will be directly or indirectly connected to one or more network interfaces 130 for communicating with a network. This type of network interface 130, also sometimes referred to as a network adapter or network interface card (NIC), translates data and control signals from computing unit 110 into network messages according to one or more communication protocols, such as the Transmission Control Protocol (TCP), the Internet Protocol (IP), and the User Datagram Protocol (UDP). These protocols are well known in the art, and thus will not be discussed here in more detail. An interface 130 may employ any suitable connection agent for connecting to a network, including, for example, a wireless transceiver, a power line adapter, a modem, or an Ethernet connection. Additionally, computing unit 110 may be configured to employ a push/pull style of network communication in transferring data between the clients and the server.

It should be appreciated that, in addition to the input, output and storage peripheral devices specifically listed above, the computing device 100 may be connected to a variety of other peripheral devices, including some that may perform input, output and storage functions, or some combination thereof.

Of course, still other peripheral devices may be included with or otherwise connected to a computer 100 of the type illustrated in FIG. 1, as is well known in the art. In some cases, a peripheral device may be permanently or semi-permanently connected to computing unit 110. For example, with many computers, computing unit 110, hard disk drive 150, removable optical disk drive 170, and a display (not shown) are semi-permanently encased in a single housing.

Still other peripheral devices may be removably connected to computer 100, however. Computer 100 may include, for example, one or more communication ports (not shown) through which a peripheral device can be connected to computing unit 110 (either directly or indirectly through bus 120). These communication ports may thus include a parallel bus port or a serial bus port, such as a serial bus port using the Universal Serial Bus (USB) standard or the IEEE 1394 High Speed Serial Bus standard (e.g., a Firewire port). Alternately or additionally, computer 100 may include a wireless data “port,” such as a Bluetooth® interface, a Wi-Fi interface, an infrared data port, or the like.

It should be appreciated that a computing device 100 may include more components than computer 100 illustrated in FIG. 1, fewer components than computer 100, or a different combination of components than computer 100. Some implementations of the invention, for example, may employ one or more computing devices 100 that are intended to have a very specific functionality, such as a smart phone or server computer. These computing devices may thus omit unnecessary peripherals, such as the network interface 130, removable optical disk drive 140, printers, scanners, external hard drives, etc. Some implementations of the invention may alternately or additionally employ computing devices 100 that are intended to be capable of a wide variety of functions, such as a desktop or laptop personal computer. These computing devices 100 may have any combination of peripheral devices or additional components as desired.

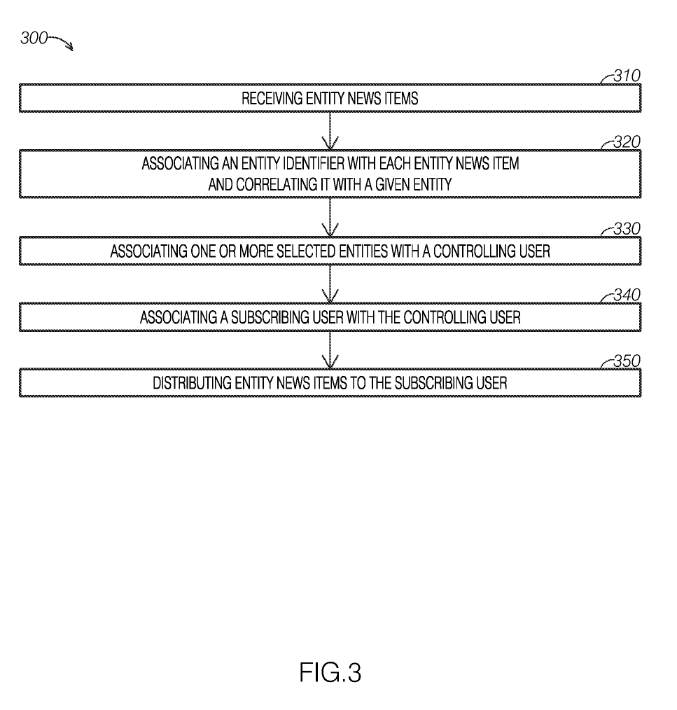

Example methods may be better appreciated with reference to the flow diagrams of FIGS. 3-8. While for purposes of simplicity of explanation, the illustrated methodologies are shown and described as a series of blocks, it is to be appreciated that the methodologies are not limited by the order of the blocks, as some blocks can occur in different orders and/or occur concurrently with other blocks from that shown and described. Moreover, less than all the illustrated blocks may be required to implement an example methodology. Furthermore, additional and/or alternative methodologies can employ additional steps that are not illustrated in blocks.

In the flow diagrams, blocks denote “processing blocks” that may be implemented with logic. In the case where the logic may be software, a flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on are not shown. It will be further appreciated that electronic and software logic may involve dynamic and flexible processes so that the illustrated blocks can be performed in other sequences that are different from those shown and/or that blocks may be combined or separated into multiple components. It will be appreciated that the processes may be implemented using various programming approaches like machine language, procedural, object oriented, and/or artificial intelligence techniques. The foregoing applies to all methodologies herein.

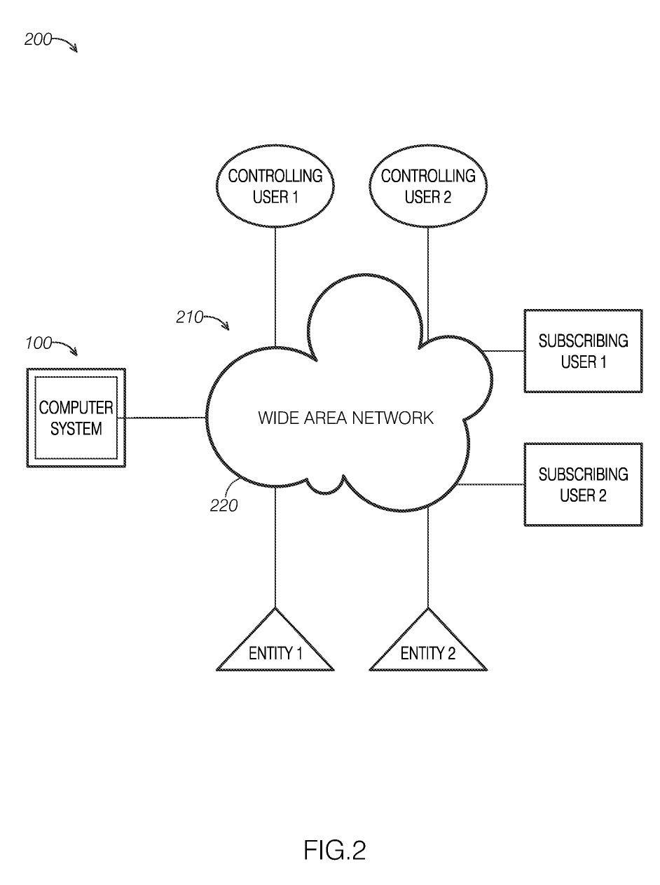

Referring now to FIG. 2, distribution system 200 includes computer system 100, a plurality of controlling users, a plurality of subscribing users, and a plurality of entities or set of entities, which interact over a computer network 210. In the example shown in FIG. 2, computer network 210 defines a wide area network (WAN) 220. However, in other examples, the computer network includes a local area network (LAN) in addition or alternatively to a WAN. Distribution system 200 is configured to provide entity news items to the subscribing users over computer network 210 via one or more of the methods described below.

Turning attention to FIG. 3, an example methodology 300 for distributing entity news items via a computer system is illustrated. Method 300 induces a controlling user interacting with a software application launched from a computer system to establish, among other tasks, a set of entities associated with both the controlling user and with the subscribing user. Once the set of entities has been associated with the controlling user and with the subscribing user, news items pertaining to the set of entities are automatically distributed to subscribing users via the computer system and over a computer network such as a WAN or a LAN or both. Additionally, the methods of the present invention may be utilized in conjunction with any number of social media networking applications.

With continuing reference to FIG. 3, block 310 illustrates the step of entity news items being received and placed into shared data storage of the computer system. These entity news items originate from entities, news sources, or bloggers and are distributed to selected subscribing users over a computer network, such as a WAN or a LAN or both. Further, entity news items may be sent to subscribing users from the computer system via a push/pull architecture.

Next, block 320 shows the step of assigning an entity identifier with each entity news item and correlating that entity news item with a given entity identifier. The method of the present invention, via a software application running on computer system 100 generates an entity identifier, similar to how relational databases assign columns (fields) and rows (records) for storage and retrieval from an information table. The entity identifier parameter is associated with a particular entity so that entity news items related to that entity can easily be retrieved, stored, and distributed to selected subscribing users.

Still referring to FIG. 3, block 330 illustrates the step of the controlling user defining a set of entities, each entity within the set being assigned its own entity identifier, and the entity identifiers being associated with the controlling user's set of entities.

Controlling users may receive entity news items from entities that are selected by clicking on a “Follow” button or other software button designated for that particular entity. Clicking on the entity's “Follow” button allows the controlling user to add that entity to the existing set of entities and will further insure entity news items are distributed to the controlling user.

Additionally or alternatively, the controlling user may selectively designate the newly added entity as one where the entity news items stemming from that particular entity are not automatically passed to other subscribing users or controlling users.

In block 340, subscribing users are associated with the controlling user's set of entities established in block 330, so that the subscribing users are able to receive entity news items that are coming from the controlling user's set of entities. Additionally, subscribing users are able to remove or disassociate from the controlling user's set of entities in order to discontinue receiving entity news items from that controlling user. Further, controlling users may initiate subscription requests from other controlling users' set of entities in order to receive those entity news items.

In one example, the subscribing user unilaterally acts to associate himself with the controlling user's set of entities. For example, the subscribing user may select a controlling user's set of entities and be automatically associated with that controlling user's set of entities. In other examples, subscribing users request authorization to become associated with the controlling user's set of entities. The controlling user is able to view pending requests by subscribing users and either approves or disapproves the subscribing user's request.

Still referring to FIG. 3, block 350 illustrates the step of distributing entity news items previously associated with a controlling user's set of entities, to subscribing users that were selected in block 340 to receive such entity news items. Because controlling users have the ability to manage the set of entities, subscribing users associated with the controlling user's set of entities will receive entity news items from a set of entities that may change continually. For example, the controlling user may add or remove entities to the set of entities on an ongoing basis.

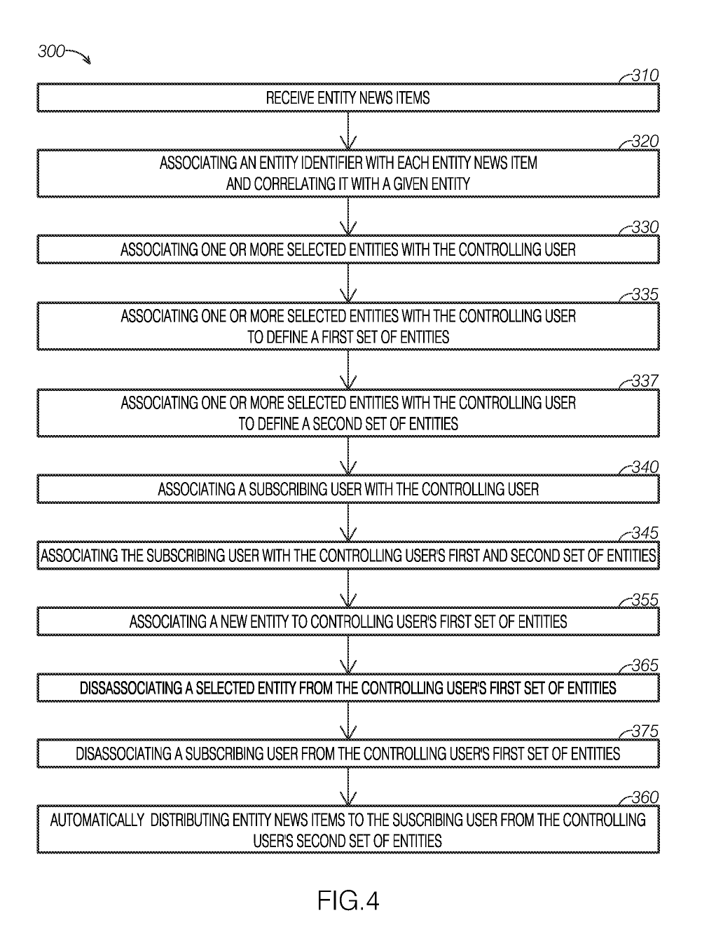

Referring now to FIG. 4, example methodology 300 is further expanded to include additional or optional steps that may be executed in the method of the present invention. Further, the embodiment in FIG. 4 may include steps similar or identical to the embodiment described in FIG. 3. Thus, for the sake of brevity, each feature of the embodiment in FIG. 3 will not be redundantly explained. Rather, key distinctions between the embodiment described in FIG. 3 and the embodiment described in FIG. 4 will be described in detail and the reader should reference the discussion above for features substantially similar between the two embodiments.

The process step in block 335 is substantially the same as described in the process step described in block 330 above. The difference here is that the controlling user associates one or more selected entities to create a first set of entities.

In block 337, the controlling user, after having previously associated one or more selected entities to the controlling user's first set of entities as described in block 335, may then select one or more entities to be associated with a controlling user's second set of entities. The controlling user, through the software application, may establish more than one set of entities. In some examples, the controlling user may determine which subscribing users receive entity news items from the sets of entities created.

The process step in block 345 is substantially the same as described in the process step described in block 340 above. The difference in block 345 is that subscribing users may be associated with either the controlling user's first or second set of entities or both as previously created in blocks 335 and/or 337 above. As in block 340, subscribing users may unilaterally act to associate themselves with the controlling user's first and/or second set of entities.

With continuing reference to FIG. 4, block 355 illustrates the step of associating a new entity to the controlling user's first set of entities. This process step is substantially similar to the process step described in block 330 above. The difference in block 355 is that the controlling user may associate a new entity to the first set of entities, as opposed to associating an existing entity to the first set.

Block 365 illustrates the step of the controlling user removing or disassociating a selected entity from the controlling user's first set of entities. Entities must be associated with the controlling user's set of entities for entity news items to be distributed to subscribing users. Thus, any entities that are not associated with the controlling user at the time entity news items are distributed will not have entity news items broadcasted to the subscribing users that are associated with the controlling user's first set of entities.

In block 375, the controlling user may disassociate subscribing users from the controlling user's first set of entities. This action stops the automatic distribution of entity news items from the controlling user's first set of entities. Further, subscribing users may also unilaterally initiate a removal or disassociation action in order to cease the receipt of entity news items from the controlling user's first set of entities.

With continuing reference to FIG. 4, block 360 illustrates the step of distributing entity news items associated with the controlling user's second set of entities to selected subscribing users. Distributing entity news items at step 360 occurs automatically without affirmative action required by the controlling user or the subscribing user.

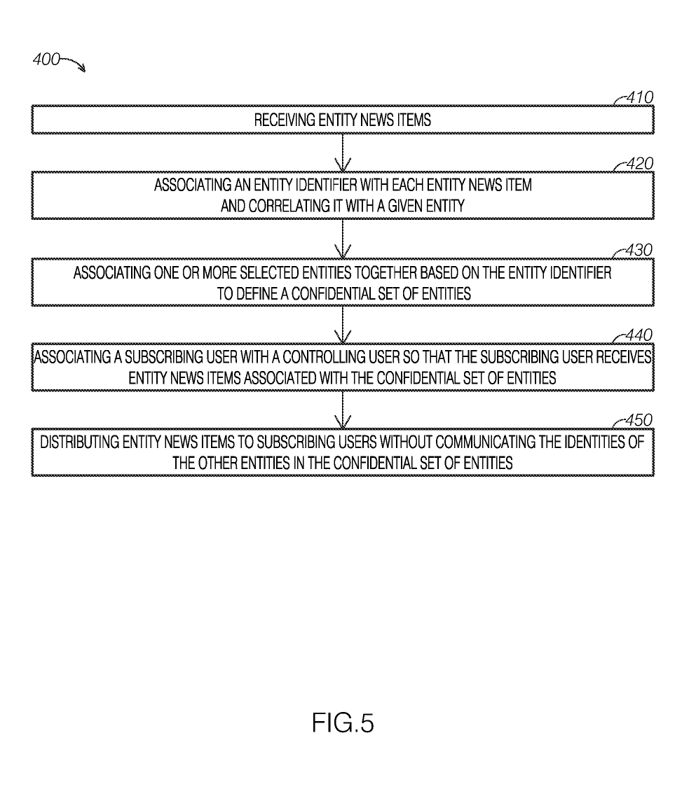

Referring now to FIG. 5, example methodology 400 is further expanded to include additional or optional steps that may be executed in the method of the present invention. Further, the embodiment in FIG. 5 may include steps similar or identical to the embodiments described in FIGS. 3 and 4. Thus, for the sake of brevity, each feature of the embodiment in FIG. 5 will not be redundantly explained. Rather, key distinctions between the embodiments described in FIGS. 3 and 4 and the embodiment described in FIG. 5 will be described in detail and the reader should reference the discussion above for features substantially similar between the two embodiments.

Turning attention to FIG. 5, at block 410 entity news items are received and placed into shared data storage of the computer system. In block 420, an entity identifier is associated with each entity news item and correlated with a given entity.

With continuing reference to FIG. 5, block 430 illustrates a similar process step as block 330 above. The noted difference in block 430 is that the controlling user's set of entities is created to keep confidential the identities of the entities contained in the set. Subscribing users associated with the controlling user's confidential set of entities will not be made aware of the list of identities of the other entities that make up the confidential set of entities. Even if the software application or the given news item reveals the identity of the particular entity associated with the given news item, the identity of the other entities in the confidential set will not be revealed.

Next, block 440 illustrates the process step of associating subscribing users with the controlling user's confidential set of entities, so that the subscribing users receive entity news items associated with that confidential set of entities.

Lastly, block 450 illustrates the process of distributing entity news items associated with a controlling user's confidential set of entities to selected subscribing users, without communicating the identities of the other entities in the controlling user's confidential set of entities. In block 450, subscribing users receiving entity news updates from the controlling user's confidential set of entities will not be aware of the identities of the other entities contained in the confidential set of entities.

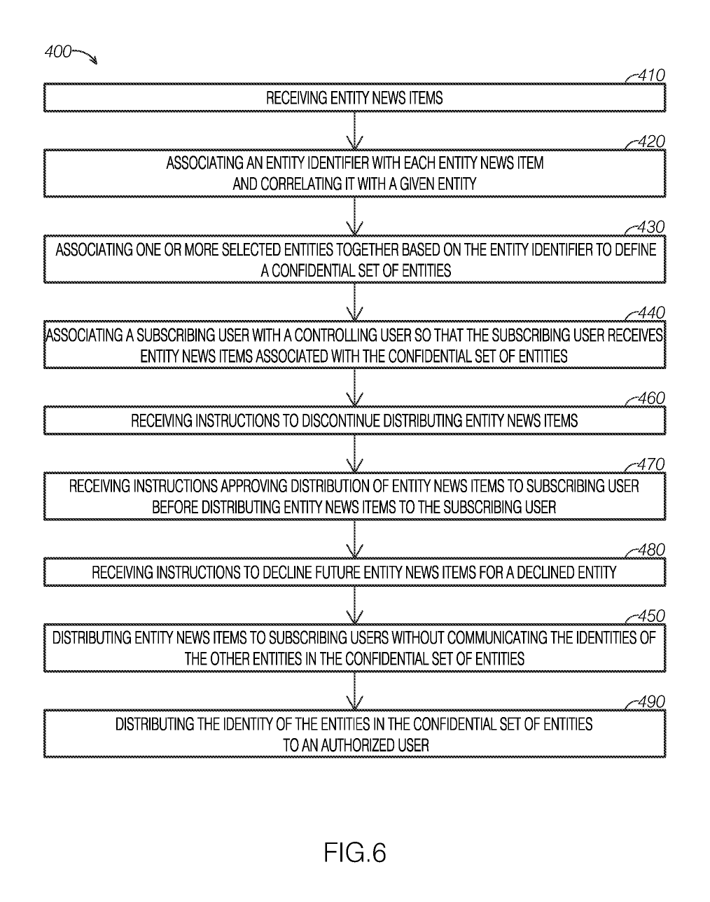

Referring now to FIG. 6, example methodology 400 is further expanded to include additional or optional steps that may be executed in the method of the present invention. Further, the embodiment in FIG. 6 may include steps similar or identical to the embodiment described in FIG. 5. Thus, for the sake of brevity, each feature of the embodiment in FIG. 6 will not be redundantly explained. Rather, key distinctions between the embodiment described in FIG. 5 and the embodiment described in FIG. 6 will be described in detail and the reader should reference the discussion above for features substantially similar between the two embodiments.

Turning attention to FIG. 6, block 460 illustrates the process step of receiving instructions to discontinue distributing entity news items associated with the controlling user's confidential set of entities to a removed or disassociated subscribing user. Upon receiving the step 460 instructions from a subscribing user, the system may remove or disassociate the subscribing user from the confidential set and not distribute further news items to that user. In one example, the instructions to discontinue distributing entity news items originate from the controlling user. In other examples, the instruction may come from subscribing users that no longer wish to receive entity news items.

Next, block 470 illustrates the process step of receiving instructions that approve the distribution of entity news items to subscribing users before actually distributing the entity news items to the subscribing users. The reader should understand that in other examples, prior approval from the controlling user may not be required.

With continuing reference to FIG. 6, block 480 shows the process step of receiving instructions to decline future entity news items from a given declined entity to a subscribing user. Method 400 enables a subscribing user to discontinue receiving entity news items from a given entity without communicating to the subscribing user the identities of the other entities in the confidential set of entities. For example, the subscribing user may click a “No more like this” button associated with the entity news item in question. Clicking this button may send a command to the computer system to remove or disassociate the declined entity from the given subscribing user so that future entity news items for that entity are not distributed to the subscribing user. In some examples, the identities of the other entities making up the confidential set of entities would not be revealed to the subscribing user.

Lastly, block 490 illustrates the process step of subscribing users distributing, to an authorized user, the identities of the entities that make up the confidential set of entities. In some situations, it may be appropriate for the identities of the entities of the confidential set of entities to be disclosed to authorized users. In other situations, controlling users and/or the application software may be responsible for distributing the identities of the entities of the confidential set of entities to authorized users.

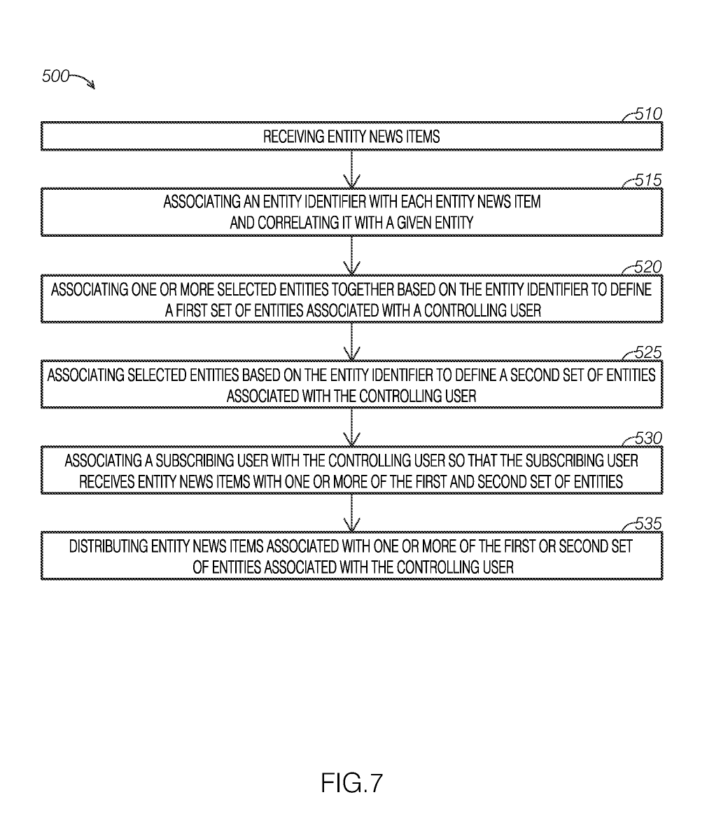

Referring now to FIG. 7, example methodology 500 is further expanded to include additional or optional steps that may be executed in the method of the present invention. Further, the embodiment in FIG. 7 may include steps similar or identical to the embodiments described in FIGS. 3-6. Thus, for the sake of brevity, each feature of the embodiment in FIG. 7 will not be redundantly explained. Rather, key distinctions between the embodiments described in FIGS. 3-6 and the embodiment described in FIG. 7 will be described in detail and the reader should reference the discussion above for features substantially similar between the two embodiments.

Turning attention to FIG. 7, at block 510 entity news items are received and placed into shared data storage of the computer system. In block 515, method 500 includes associating an entity identifier with each entity news item and correlating it with a given entity.

With continuing reference to FIG. 7, blocks 520 and 525, are similar to the process step 330 above. However, noted differences in blocks 520 and 525 respectively, are that the controlling user selects one or more entities to define a first set of entities in block 520, as differentiated from a second set of entities in block 525. Method 500 highlights that the controlling user may establish more than one set of entities, while method 300 highlights that the controlling user may define a single set of entities.

At step 530, subscribing users are associated with the controlling user's set of entities, so that subscribing users are able to receive entity news items that are coming from the controlling user's set of entities. A distinguishing difference in block 530 from block 340 above is that subscribing users may receive entity news items from either the controlling user's first set of entities or second set of entities.

At block 535, entity news items, previously associated with the controlling user's set of entities are distributed to the subscribing users. A notable difference in block 535 is that subscribing users may be receiving entity news items from the controlling user's first set of entities, or from the controlling user's second set of entities, or both.

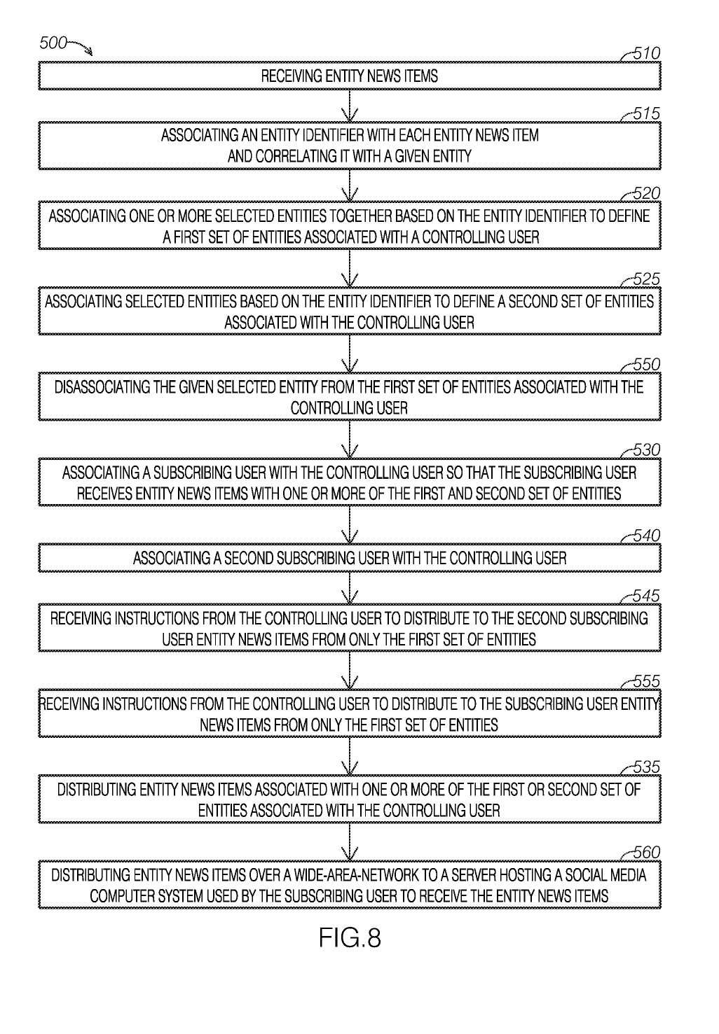

Referring now to FIG. 8, example methodology 500 is further expanded to include additional or optional steps that may be executed in the method of the present invention. Further, the embodiment in FIG. 8 may include steps similar or identical to the embodiments described in FIG. 7. Thus, for the sake of brevity, each feature of the embodiment in FIG. 8 will not be redundantly explained. Rather, key distinctions between the embodiments described above and the embodiment described in FIG. 8 will be described in detail and the reader should reference the discussion above for features substantially similar between the embodiments.

Turning attention to FIG. 8, block 540 illustrates the process step of associating a second subscribing user with the controlling user. FIG. 8 demonstrates that new subscribing users can be associated with the controlling user on an ongoing basis. The method may further include distributing entity news items associated with either the controlling user's first set of entities or second set of entities, or both to the second subscribing user.

Next, block 545 illustrates the process step of receiving instructions from the controlling user to distribute news entity items only associated with the controlling user's first set of entities to the second subscribing user. Here, the controlling user is able to control from which set of entities a second subscriber user can receive entity news items. Additionally, the controlling user may associate an entity with both a first set of entities and a second set of entities.

With continuing reference to FIG. 8, block 550 illustrates the process step of removing or disassociating a selected entity from the controlling user's first set of entities, but keeping that same selected entity associated with the controlling user's second set of entities. This process step allows controlling users the enhanced versatility to add or delete selected entities from various sets of entities that have been associated with the controlling user.

In block 555, the process step of receiving instructions from the controlling user to distribute entity news items to the subscribing user from the first set of entities is illustrated. Here, the controlling user has the ability to control from which set of entities the subscribing user will receive entity news items. In this example, the subscribing user receives entity news items from the controlling user's first set of entities, but will not receive entity news items from the controlling user's second set of entities.

Lastly, block 560 illustrates the process step of distributing entity news items to the subscriber user over a WAN via a server hosting a social media computer system used by the subscribing user. Suitable social media computer systems include systems providing content from Facebook®, LinkedIn®, Twitter®, and Google Plus®. As method 500 demonstrates, the present invention may be implemented so that subscribing users are able to receive entity news items remotely over a WAN. Distributing entity news items over LANs or combinations of WANs and LANs is contemplated as well.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

I claim:

1. A method for distributing entity news items to one or more select users via a computer system including a central processing unit and a shared data storage cooperating with the central processing unit, the method comprising the steps of:
receiving a plurality of entity news items for a plurality of entities into the shared data storage;
associating, with the central processing unit executing computer executable instructions, an entity identifier with each entity news item to correlate each entity news item with a given entity;
associating, with the central processing unit executing computer executable instructions, one or more selected entities with a controlling user based on the entity identifier to define a controlling user set of entities;
associating, with the central processing unit executing computer executable instructions, a subscribing user with the controlling user so that the subscribing user receives entity news items associated with the one or more selected entities included in the controlling user set of entities; and
distributing to the subscribing user, with the central processing unit executing computer executable instructions, entity news items associated with the one or more selected entities included in the controlling user set of entities to the subscribing user.

2. The method of claim 1, wherein the controlling user set of entities defines a controlling user first set of entities and further comprising associating, with the central processing unit executing computer executable instructions, one or more selected entities with the controlling user to define a controlling user second set of entities.

3. The method of claim 2, further comprising distributing, with the central processing unit executing computer executable instructions, entity news items associated with the one or more selected entities included in the controlling user second set of entities to the subscribing user.

4. The method of claim 1, further comprising disassociating, with the central processing unit executing computer executable instructions, a selected entity from the controlling user set of entities.

5. The method of claim 1, further comprising associating, with the central processing unit executing computer executable instructions, a new entity to the controlling user set of entities.

6. The method of claim 1, further comprising receiving, with the central processing unit executing computer executable instructions, instructions disassociating the subscribing user from the controlling user.

7. The method of claim 1, wherein distributing entity news items includes automatically distributing entity news items to the subscribing user after associating the subscribing user with the controlling user.

8. The method of claim 1, wherein distributing entity news items includes distributing entity news items over a computer network.

9. A method for distributing entity news items to one or more select users via a computer system including a central processing unit and a shared data storage cooperating with the central processing unit, the method comprising the steps of:
receiving a plurality of entity news items for a plurality of entities into the shared data storage;
associating, with the central processing unit executing computer executable instructions, an entity identifier with each entity news item to correlate each entity news item with a given entity;
associating, with the central processing unit executing computer executable instructions, one or more selected entities together based on the entity identifier to define a confidential set of entities;
associating, with the central processing unit executing computer executable instructions, a subscribing user with a controlling user so that the subscribing user receives entity news items associated with the confidential set of entities;
distributing to the subscribing user, with the central processing unit executing computer executable instructions, entity news items associated with the confidential set of entities without communicating the identity of the other entities associated with the confidential set of entities.

10. The method of claim 9, further comprising:
receiving, with the central processing unit executing computer executable instructions, instructions from the subscribing user to discontinue receiving entity news items associated with the confidential set of entities; and
not distributing entity news items associated with the confidential set of entities to the subscribing user.

11. The method of claim 9, further comprising receiving, with the central processing unit executing computer executable instructions, instructions approving distribution of entity news items to the subscribing user before distributing entity news items to the subscribing user.

12. The method of claim 9, further comprising, receiving, with the central processing unit executing computer executable instructions, instructions to decline future entity news items for a declined entity in the confidential set of entities without communicating to the subscribing user, the identities of the other entities in the confidential set of entities.

13. The method of claim 9, wherein the subscribing user defines a general user, further comprising distributing the identity of the entities in the confidential set of entities to an authorized user.

14. A method for distributing entity news items to one or more select users via a computer system including a central processing unit and a shared data storage cooperating with the central processing unit, the method comprising the steps of:
receiving a plurality of entity news items for a plurality of entities into the shared data storage;
associating, with the central processing unit executing computer executable instructions, an entity identifier with each entity news item to correlate each entity news item with a given entity;
associating, with the central processing unit executing computer executable instructions, one or more selected entities together based on the entity identifier to define a first set of entities associated with a controlling user;
associating, with the central processing unit executing computer executable instructions, one or more selected entities together based on the entity identifier to define a second set of entities associated with the controlling user;
associating, with the central processing unit executing computer executable instructions, a subscribing user with the controlling user so that the subscribing user receives entity news updates associated with one or more of the first and second set of entities associated with the controlling user, and
distributing to the subscribing user, with the central processing unit executing computer executable instructions, entity news items associated with one or more of the first or second set of entities associated with the controlling user.

15. The method of claim 14, wherein the subscribing user defines a first subscribing user, further comprising:
associating, with the central processing unit executing computer executable instructions, a second subscribing user with the controlling user;
distributing to the second subscribing user, with the central processing unit executing computer executable instructions, entity news items associated with one or more of the first or second set of entities associated with the controlling user.

16. The method of claim 15, further comprising receiving, with the central processing unit executing computer executable instructions, instructions from the controlling user to distribute to the second subscribing user entity news items from only the first set of entities.

17. The method of claim 14, wherein a given selected entity is included in both the first set of entities and the second set of entities associated with the controlling user.

18. The method of claim 17, further comprising disassociating, with the central processing unit executing computer executable instructions, the given selected entity from the first set of entities associated with the controlling user and retaining the given selected entity in the second set of entities associated with the controlling user.

19. The method of claim 14, further comprising receiving, with the central processing unit executing computer executable instructions, instructions from the controlling user to distribute to the subscribing user entity news items from only the first set of entities.

20. The method of claim 14, wherein distributing entity news items includes distributing entity news items over a wide-area-network to a server hosting a social media computer system used by the subscribing user to receive the entity news items.
